(19) United States
(12) Patent Application Publication
(10) Pub. No.: US 2009/0057438 A1
(43) Pub. Date: Mar. 5, 2009

(54) Ultrasonically activated fuel injector needle

(75) Inventors: Peter Hofbauer, West Bloomfield, MI (US); Adrian Nicolaie Tusinean, Windsor (CA)

Correspondence Address: PAUL K. GODWIN;Paul K. Godwin, P.C., 7218 Pine Vista Dr., Brighton, MI, 48116, US

(73) Assignee: Advanced Propulsion Technologies, Inc., Goleta, CA (US)

(21) Appl. No.: 12/229,871

(22) Filed: Aug. 27, 2008

Related U.S. Application Data
(60) Provisional application No. 60/966,862, filed on Aug. 28, 2007.

(51) Int. Cl. B05B 1/08

(52) U.S. Cl. 239/102.2

(57) ABSTRACT

A fuel injector intended for use on an internal combustion engine contains an injector needle that is longitudinally driven by an ultrasonic actuator during the time the injector valve is open to provide an atomized fuel spray output of sub-micron droplet sizes. A piezoelectric disk stack is mounted within the injector housing to surround a portion of the injector needle component and is used to provide the mechanical ultrasonic stimulation to the injector valve at the end of the injector needle and set up a corresponding wave-front at the injector valve to atomize the fuel as it leaves the injector nozzle.

### RELATED APPLICATION

This application claims the benefit of U.S. provisional application Ser. No. 60/966,862 filed on Aug. 28, 2007, under 35 U.S.C. 119(e).

### BACKGROUND

1. Field of the Invention

The invention is directed to the field of fuel injectors of the type employed in internal combustion engines and more specifically to the area of spray control.

2. Description of the Prior Art

Fuel injectors typically use needle valves and various devices to control the movement of a needle from its normally closed valve seat to an open position in order to allow pressurized fuel to be sprayed into a combustion chamber of an internal combustion engine.

A major goal in the development of fuel injectors is to obtain a fine or atomized spray of fuel vapor into the combustion chamber. The smaller the droplets the more surface area is provided for mixing with air in the combustion chamber. The greater the mixture, the more even and thorough is the subsequent combustion. This results in a more efficient power usage and less waste by-products.

Traditionally, this has involved more and smaller spray nozzle orifices and fuel pumped at very high pressures through the orifices. In each case, the challenges to producing the desired fine spray are significant. For example, multiple but smaller orifices present more surface area and resistance to the fuel passing through and are more susceptible to blockage by particles or coking. Higher pump pressures also present the need for stronger connections, piping and injector springs, as well as more expensive pumping sources.

### SUMMARY OF THE INVENTION

The present invention achieves the goal of atomizing the spray of fuel vapor from a fuel injector by applying an ultrasonic vibration to the needle when the needle valve is in an open condition.

The longitudinal vibrations of the needle, preferably at its natural frequency, cause the end tip of the needle to ultrasonically drive or pump the fuel through the nozzle orifices and to generate an atomized spray into the combustion chamber.

Because the fuel is driven at the nozzle orifices by the tip of the needle, the fuel pressure need not be increased beyond that which is necessary to drive the needle to its open position, nor is it necessary to provide exceptionally small orifices in the nozzle to achieve the desired atomized spray. The vibration of the tip at an ultrasonic frequency enhances the spray and reduces the size of the droplets to sub-micron sizes.

An embodiment of the invention is shown to be a modification of a conventionally driven and activated fuel injector. The modification includes a piezoelectric stack that forms an ultrasonic actuator mounted to surround a portion of the needle. The actuator is activated by an electrical signal to vibrate the needle longitudinally at the desired ultrasonic frequency during its open condition, i.e., during the time the needle is raised from its seated closed position.

### BRIEF DESCRIPTION OF THE DRAWINGS

FIG. 1 represents a prior art fuel injector.

FIG. 2 is a cross-sectional plan view of the lower end of a fuel injector containing elements of the present invention.

FIG. 3 is an enlarged view of the nozzle end of the fuel injector shown in FIG. 2.

FIG. 4 is a cross-sectional plan view of the lower end of a fuel injector containing additional elements of the present invention.

FIG. 4A is an end view representation of the piezo stack and wiring within the actuation chamber shown in FIG. 4.

FIG. 5 is an enlarged view of the ultrasonic actuation portion of the fuel injector shown in FIG. 3 with the needle in its closed position.

FIG. 6 is an enlarged view of the ultrasonic actuation portion of the fuel injector shown in FIG. 3 with the needle in its fully open position.

FIG. 7 is a plot representation of the movement of the needle tip during the open portion of the injector valve cycle.

FIG. 8 is an enlarged view of the nozzle end of the fuel injector during the open portion of the injector valve cycle.

### DETAILED DESCRIPTION OF THE PREFERRED EMBODIMENT

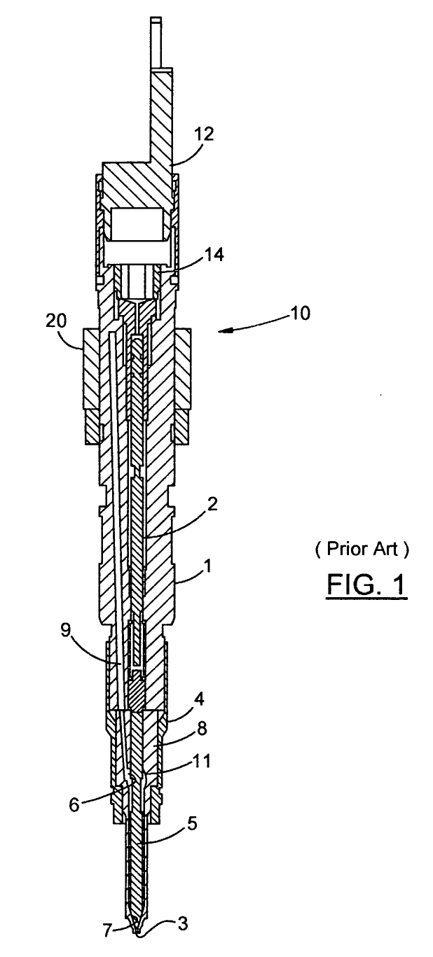

A prior art fuel injector 10 is shown in FIG. 1. The injector 10 includes an upper housing 1 which is mountable to a cylinder of an internal combustion engine. (not shown). The upper housing 1 is a cylindrically formed element that supports all the other parts of the injector. The upper housing includes a central needle bore 2 and other cavities to support a metering valve 12 at its exposed upper end and an upper needle spring 14. A fuel passage 9 is also contained in the upper housing 1 to deliver fuel under high pressure from an injector pump (not shown) to the lower end of the injector. A lower housing 4 is shown attached to the lower end of the upper housing 1. Lower housing 4 is an extension of the upper housing 1 and is used in the manufacturing assembly of the injector. Lower housing 4 supports and captures a valve housing 8 while attaching the same to the upper housing 1. Valve housing 8 defines an internal nozzle chamber 11 that is in communication with fuel passage 9 and a nozzle 3 at the end of housing 8. Nozzle 3 contains one or more orifices and housing 8 provides an internal valve seat for injector needle tip 7 upstream of nozzle 3. An injector needle 5 is slideably mounted within needle bore 2 and is held in a normally closed position by an upper spring 14 and the pressure of fuel present in the upper chamber 15 that is located in upper housing 1. Injector Needle 5 can be made of one or more elements of lightweight (low mass) metal designed to allow its instantaneous movement within the bore and provide low inertia mass resistance to the movement. In response to actuation of metering valve 12, the pressure in upper chamber 15 is released and high pressure fuel in nozzle chamber 11 acts on the shoulder of needle 5 within nozzle chamber 11 to move the needle up, overcoming the biasing force of spring 14. Simultaneously, as needle 5 is moved to cause its tip 7 to become unseated and open the valve, the fuel entering that space, from bore 2 surrounding the lower end of needle 5, provides pressure against tip 7 and adds to the pressure present at the shoulder. This additional pressure forces the needle further up to fully open the valve, thereby allowing the high pressure fuel to escape the injector at full volume through nozzle 3 and to be sprayed into the combustion chamber.

The present invention is embodied in a fuel injector and is suitable to be implemented in prior art injectors, such as that shown in FIG. 1 or other injectors designed to take advantage of the superior results offered by the invention.

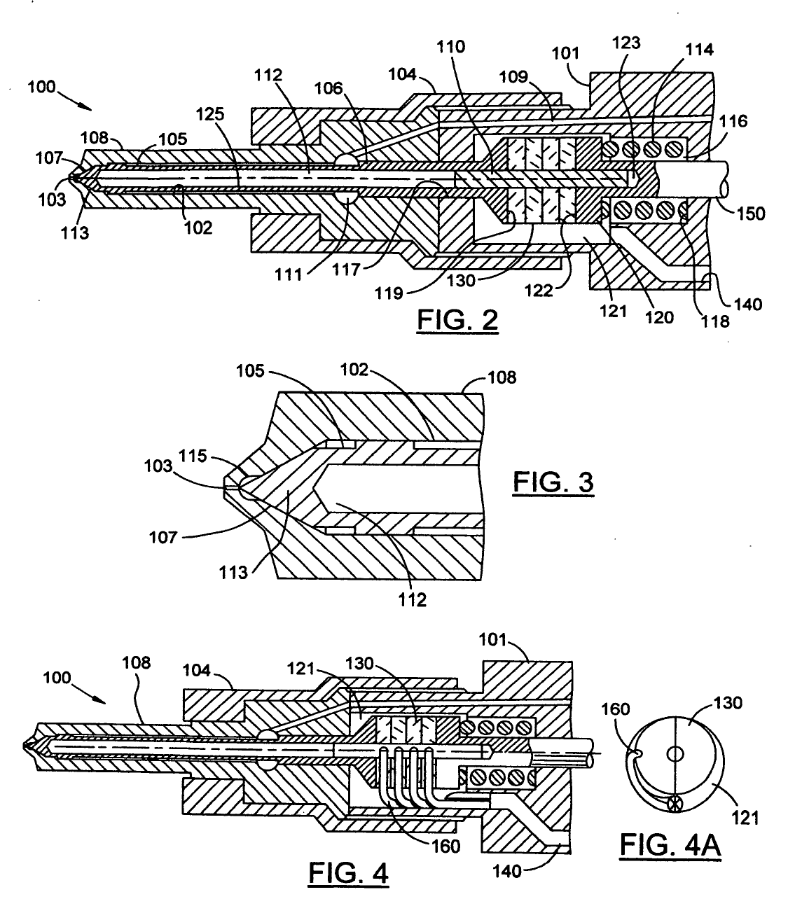

In FIG. 2, the lower end of a fuel injector 100 containing the present invention is shown in cross-section. An upper housing 101, a lower housing 104 and a valve housing 108 together form the support structure of injector 100. Upper housing 101 and valve housing 108 contain aligned needle bores 117 and 102, respectively, into which an injector valve needle 105 is located for axial movement therein. A nozzle 103 containing a plurality of orifices is formed in the end of valve housing 108 and communicates with needle bore 102. An actuation chamber 121 is formed in upper housing 101 as an extension of a spring chamber 116. High pressure fuel passage 109 extends through upper housing 101 to a nozzle chamber 111 location between actuation chamber 121 and nozzle 103.

Valve needle 105 is made up of several elements which include a plunger 150, a plunger flange 120, an actuator rod 110, a casing 106, a needle body 125 with a tapered surface valve tip 107. Plunger 150 is controlled in a conventional way from the upper portion of the housing by a metering valve or other suitable control mechanism. Such control provides a biasing pressure on plunger 150 over and above the bias pressure from biasing spring 114 to hold the valve closed when no fuel injection is desired and to relieve the pressure when fuel injection is desired. Plunger 150 extends into spring chamber 116 and actuation chamber 121 where its flange 120 abuts against biasing spring 114. Spring 114 is compressed between the closed wall 118 of the spring chamber and the plunger flange 120 to provide the desired amount of biasing force to the valve needle 105.

Actuator rod 110 is preferably a solid metal structure that has a desired degree of axial elasticity. Actuator rod 110 is fixedly attached to plunger 150 and casing 106. Plunger 150 contains a central bore 123. Needle body 125 and casing 106 together contain an axial void 112 to provide reduced mass in valve needle 105. Actuator rod 110 has one end fixedly secured in the upper end of void 112 in casing 106, and its other end fixedly secured in bore 123 of plunger 150. The opposite end of needle body 125 contains a tapered valve tip 107 that conforms to the inner valve seat 113 in valve housing 108. An ultrasonic actuator 130 is located between the outer face 122 of plunger flange 120 and the face 119 of casing 106.

Ultrasonic actuator 130 is a made up of a stack of piezoelectric discs or plates, which are individually coated with an electrically conductive surface layer. Each disk is individually contacted electrically and energized by the electrical source. Due to the nature of piezoelectric crystals, they expand and contract when electrically energized. In this case, the stack axis is the axis of linear motion. Each disk is annular in shape and surrounds the actuator rod 110. By applying a voltage across each disk the total stack lengthens. The elongation of a stack is roughly proportional to the stack's length (the longer the stack, the larger the expansion) and generally, the maximum achievable strain is on the order of 1-2%. When an alternating voltage is applied, the stack expands and contracts at that frequency. A natural or resonant frequency of the valve needle can be selected to gain efficiencies.

FIG. 3 is an enlarged illustration of the injector valve tip 107 extending from needle 105. Tip 107 is shown resting against seat 113 which is adjacent nozzle 103 and stack 115. Tip 107 is shown in its normally biased closed condition to seal and prevent fuel present in needle bore 102 from escaping through nozzle 103 and into the combustion chamber.

When injector needle 105 is moved in a conventional manner (to the right in the drawings) to disengage valve tip 107 from its contact with seat 113, fuel present in needle bore 102 will escape under pressure through nozzle 103 and into the combustion chamber. The location of needle 105 to its open position is represented in FIG. 8.

FIGS. 4 and 4A additionally show wires 160 that are individually connected between an ultrasonic energy source (not shown) and each electrode of the piezoelectric disks that make up the ultrasonic actuator 130. The figures further show a preferred routing of wires 160 through a passage 140 and into actuation chamber 121. In this case, (see FIG. 4A) actuator chamber 121 is structured as a cylinder that is considerable larger than the piezoelectric stack in order to accommodate all of the actuator components. Actuator 130, which is centered on actuator rod 110 within lower housing 104 and valve housing 108, is located to one side of actuator chamber 121. This location provides sufficient clearance for wires 160, and accommodates the lower opening of passage 140. The size is further determined by how much movement the wires require when the injector needle 105 is moved in a conventional manner during operation without incurring excessive wear on the wires.

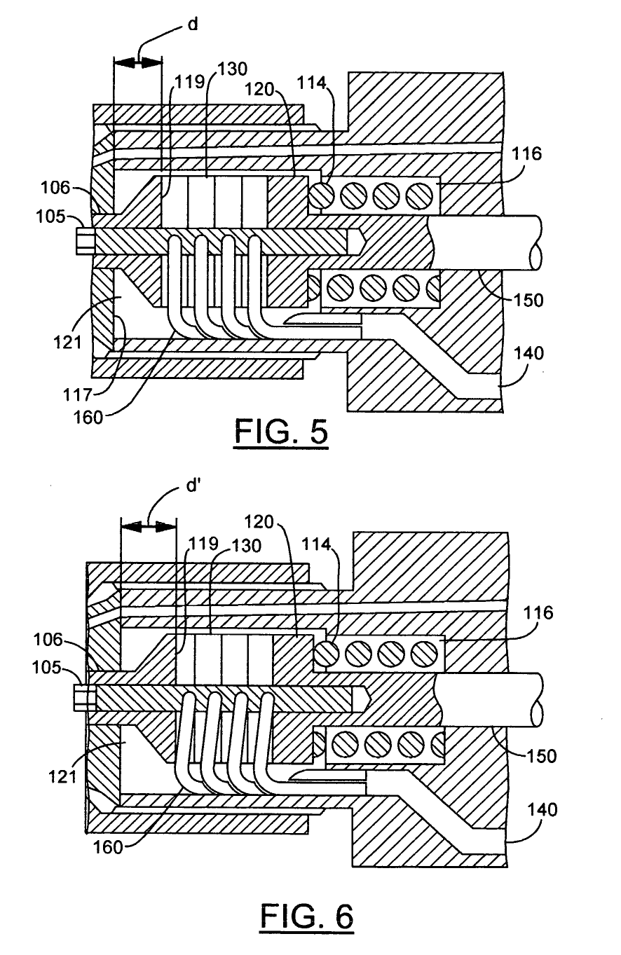

FIGS. 5 and 6 show the location of plunger 150, plunger flange 120, wires 160 and other actuation components when injector needle tip 107 is in both closed (FIG. 5) and open (FIG. 6) conditions. As can be seen from these figures, when the plunger 150 is biased to hold the injector closed, casing face 119 is located at a distance (d) as measured from a reference point in actuation chamber 121, such as from forward wall 117. When the pressure on plunger 150 is released, and fuel pressure forces needle 105 to be moved to an open condition. Therefore, plunger 150, plunger flange 120 and the ultrasonic actuator components, including casing face 119 all move to a second position. That position is shown in FIG. 6 as the distance (d′) measured from the reference point mentioned above to casing face 119.

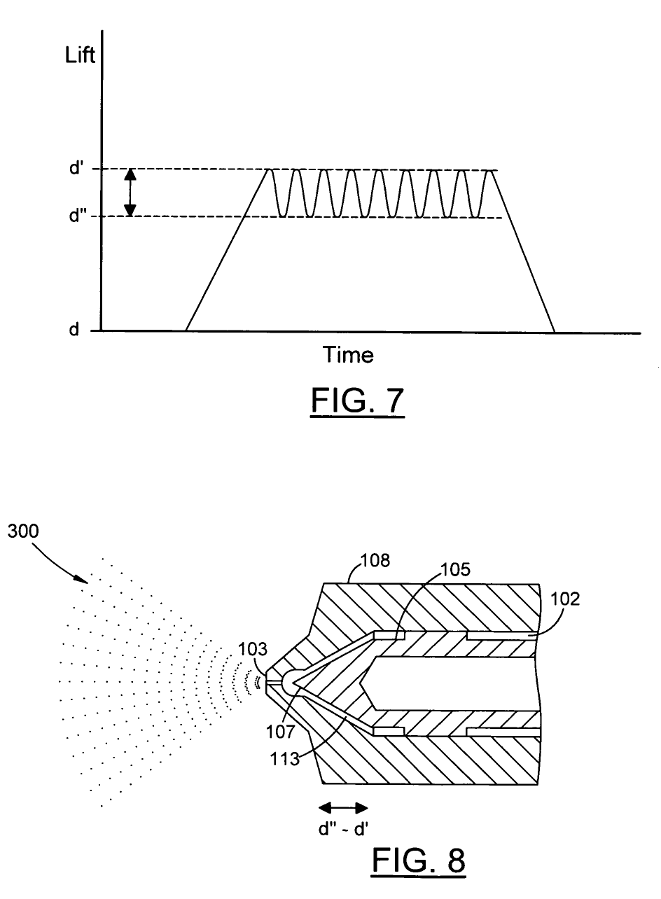

When energized while the injector valve is open (FIG. 6), piezoelectric disks that make up the ultrasonic actuator 130 expand and contract at a predetermined frequency and cause corresponding axial movement of the casing 106 and the needle tip 103 by expanding and contracting the length of actuator rod 110. When energized to vibrate at a predetermined ultrasonic frequency that is selected to be the fundamental resonant frequency of the needle 105, valve tip 107 is moved from its fully open position at (d′) a slight amount (d″) towards its closed position that is represented in FIGS. 7 and 8.

This application of ultrasonic vibration to the injector needle occurs only during the time the injector needle valve is open. When the valve is closed (between injection portions of the engine cycle), the actuator 130 is not energized. During the time the actuator 130 is energized, a wave-front is established at valve tip 107 to cause to cause ultrasonic pulsation and cavitation of the fuel being injected through nozzle 103. The resulting fuel cloud 300 is atomized and provides sub-micron sized droplets that, in total, present greater surface area than conventional droplets. Because of the greater surface area, the atomized spray serves to enhance the mixing of the fuel with air. This results in more complete and even burning during the combustion portion of the associated engine cycle. Complete and even burning increases the power efficiency of the engine by reducing wasted combustion gases and heat, since more complete burning means more of the energy is converted to mechanical expansion power.

As can be seen by the drawings and accompanying explanation, the present invention is a unique improvement over conventional fuel injectors. And while the embodiment shown here is the preferred embodiment, it shall not be considered to be a restriction on the scope of the claims set forth below.

We claim:

1. A fuel injector for use in an internal combustion engine comprising:
a housing;
an injector needle mounted within said housing for axial movement therein to open and close a fuel injector valve;
a nozzle located in said housing adjacent said valve to provide a path for fuel to escape from said fuel injector and to enter the combustion chamber of said engine; and
an ultrasonic actuator for driving said injector needle at a predetermined ultrasonic frequency when said injector valve is open.

2. A fuel injector as in claim 1, wherein said ultrasonic actuator includes a plurality of piezoelectric disks circumferentially positioned around said injector needle.

3. A fuel injector as in claim 2, wherein said piezoelectric disks are each coated with an electrically conducting layer on each surface, and each layer is electrically energized to cause said disks to vibrate at said ultrasonic frequency when said injector valve is open.

4. A fuel injector as in claim 1, wherein said ultrasonic actuator includes a plurality of annular shaped piezoelectric disks having a center opening and being stacked and positioned around said injector needle.

5. A fuel injector as in claim 1, wherein said injector needle is longitudinally expanded and contracted by said ultrasonic actuator.

6. A fuel injector as in claim 1, wherein said injector needle is driven at said ultrasonic frequency that is the resonant frequency of said injector needle to establish a corresponding wave-front in said fuel as it is driven through said injector valve.

7. A fuel injector as in claim 1, wherein said injector needle has a valve tip that is driven at said ultrasonic frequency that is the resonant frequency of said injector needle to establish a corresponding wave-front in said fuel as said fuel is forced through said injector valve.

8. A fuel injector as in claim 1, wherein said injector needle is driven at said ultrasonic frequency and causes said fuel to be atomized as it leaves said injector valve.

9. A fuel injector for use in an internal combustion engine comprising:
a housing;
an injector needle containing a valve tip at one end and mounted within said housing for axial movement therein to use said valve tip end to open and close a fuel injector valve;
a nozzle located in said housing adjacent said valve to provide an open path for fuel to escape from said fuel injector and to enter the combustion chamber of said engine; and
an ultrasonic actuator for vibrating said valve tip end of said injector needle at a predetermined ultrasonic frequency when said injector valve is open;
said ultrasonic actuator includes a plurality of annular shaped piezoelectric disks circumferentially positioned around said injector needle;
wherein said injector needle is longitudinally expanded and contracted by said ultrasonic actuator; and
said valve tip is vibrated at said ultrasonic frequency to establish a corresponding wave-front in said fuel as it is driven through said injector valve.

10. A fuel injector as in claim 9, wherein said injector needle is vibrated at said ultrasonic frequency and causes said fuel to be atomized as it leaves said injector valve.

11. A fuel injector as in claim 9, wherein said ultrasonic actuator is electrically energized to cause said disks to vibrate at said ultrasonic frequency.

12. A fuel injector as in claim 9, wherein said piezoelectric disks are each coated with an electrically conducting layer on each surface and each layer is connected to receive electrical energization.

13. A method of atomizing fuel injected into the combustion chamber of an internal combustion engine comprising the steps of:
providing a fuel injector containing a controlled metering valve and nozzle for injecting predetermined quantities of fuel under pressure to enter said combustion chamber during the operation of said engine;
vibrating said metering valve of said fuel injector at a predetermined ultrasonic frequency during the time when said metering valve is open.

14. A method as in claim 13, wherein said step of vibrating is performed by providing an ultrasonic actuator in said fuel injector to vibrate said metering valve when said metering valve is open.

15. A method as in claim 14, wherein said step of vibrating is further performed by electrically energizing said ultrasonic actuator during the time said metering valve is open.

16. A method as in claim 15, wherein said step of providing said ultrasonic actuator includes the step of providing piezoelectric crystals within said fuel injector so as to responsively vibrate said metering valve when electrically energized.

17. A method as in claim 16, wherein said piezoelectric crystals are provided as a layered stack of disks that are each coated with an electrically conductive surface connected to be electrically energized during the time said metering valve is open.

18. A method as in claim 17, wherein metering valve is attached to the end of an actuated injector needle and said disks are provided with an annular shape and placed within said fuel injector to surround said injector needle.

19. A method as in claim 18, wherein said step of vibrating said metering valve is achieved by the longitudinal expansion and contraction of said injector needle by said ultrasonic actuator when electrically energized during the time said metering valve is open.

20. A method as in claim 19, wherein said step of providing said ultrasonic actuator includes the step of mechanically connecting said actuator to said injector needle to force the expansion and contraction of said injector needle.
